(19) United States
(12) Patent Application Publication
(10) Pub. No.: US 2008/0155686 A1
(43) Pub. Date: Jun. 26, 2008

(54) PROFILE VERIFICATION SYSTEM

(76) Inventor: Guy Knighteson McNair, Los Gatos, CA (US)

Correspondence Address: Patent Venture Group, 10788 Civic Center Drive, Suite 215, Rancho Cucamonga, CA, 91730-3805, US

(21) Appl. No.: 12/041,997

(22) Filed: Mar. 4, 2008

Related U.S. Application Data
(63) Continuation of application No. 11/565,536, filed on Nov. 30, 2006.
Application No. 11/565,536 is a continuation of application No. 10/759,361, filed on Jan. 16, 2004, now abandoned.

(51) Int. Cl. G06F 17/30; G06F 7/10; G06F 21/00

(52) U.S. Cl. 726/21; 707/5; 707/E17.017

(57) ABSTRACT

A digital information verification (DIV) system (10) wherein a process controller (12) directs operation of a database manager (14) and a search engine (16) that access a personal base (20) and an entity base (22) containing information provided by individual-members (30) and entity-members (32), collectively users (34) of the DIV system (10). The users (34) access the DIV system (10) via user access devices (28), a communication unit (26), and an authentication processor (24) that determines the nature of each user (34) based on an ID number (44, 54) and password. The information provided by the users (34) is stored in personal records (40) and entity records (50), respectively stored in the personal base (20) and entity base (22), and can become verified information based upon comparison.

### CROSS-REFERENCE TO RELATED APPLICATIONS

This application claims the benefit of U.S. Provisional Application No. 60/307,549, filed Jul. 23, 2001.

### TECHNICAL FIELD

The present invention relates generally to computer-implemented systems used to verify, authenticate, or certify information exchanged between individuals and organizations. It is anticipated that primary application of the present invention will be in applying for employment, credit, and housing. However, the present invention is also well suited to use other applications where individuals seek an easy way to provide verified information to organizations and where organizations seek to locate candidate individuals based on verified information.

### BACKGROUND ART

There presently exists a great and growing need for information. For example, business organizations such as employers, lenders, educational institutions, housing providers, etc. need to make major decisions about individuals, decisions that often will involve long term commitments. Furthermore, as our transportation and communications infrastructures have gotten faster, the expectation is that such decisions will be made faster, particularly if an entity wishes to remain competitive in its respective marketplace.

Competing with this need for information are needs to insure that it is trustworthy and properly used. The information that organizations or entities need about individuals often needs to be authenticated or verified. Yet those providing the information or whom it is about will not contribute to or facilitate the use of the information if they fear that it will be misused.

For one example, consider employment, particularly modern job or placement searching (although the principals described here largely apply to the traditional context as well). Currently, there are numerous job posting and resume matching services such as the SAN JOSE MERCURY NEWS, CAREERBUILDER, CAREERPATH, etc., that allow employers to post job openings online and allow candidates or employment seekers to post resumes online. These systems allow candidates and employers to find one another by allowing the candidates to search and apply for the jobs advertised within the respective system, and the employers to search for and contact the candidates that meet their requirements. Unfortunately, while the privacy of accessibility of such systems is questionable, another important issue that impedes the hiring decisions is the validity of the information found in the resume bases. Heretofore, there has not been made available a comprehensive management system with authenticated information; a secure automated system that assures the validity of each applicant; a delivery mechanism that prevents fraud or misuse; and an instantaneous online verification system to proactively manage and disseminate personal information with a degree of control and privacy.

From the above it is clear that the employer needs verified information about the prospective employees. Among other details, it needs to know their education and skills, and where and in what capacity they have worked elsewhere. It may also be desirable to have and to consider information which knowledgeable or authoritative others may contribute about the individual. That is, to receive references.

At the same time, the prospective employee needs some assurances. Will the information be properly used? Will that be only by the intended prospective employer, and then only for prospective employment purposes, or for other uses and by others as well? Obviously, individuals will feel disinclined to use a system where others are privy to every detail provided; or where present employers can easily discover who is considering leaving, and then preemptively discharge people or change job assignments; or one where outside marketers can use the information, say, to make sales pitches based on statistics showing that aggressively upward mobile accounts are good prospects to buy mid-sized automobiles manufactured in Northern Europe.

The prospective employee would also like assurances that information about them will be complete and accurate. Clerical errors in records keeping are inevitable, and can be particularly damaging if about periods in school, titles of positions held, skill test scores, etc. Individuals will also be more willing to let information be used if they can trust it to convey what it is intended to convey. For instance, we have all probably had somebody we would like to have used as a reference, say, an eccentric professor too long mentally confined in an ivory tower, but that we were worried might say something well intentioned yet “awkward.”

Thus our great and growing need for information is a problem with a number of facets. On one hand, the party receiving the information needs to be able to trust in its completeness and veracity. And on the other hand, the party providing or being the subject of the information needs to be able to trust in its integrity, accuracy and the scope of its dissemination. Furthermore, the problem is really not one related to separate bits and pieces of data, but rather one encompassing entire profiles of information.

Returning to our employment example, consider the present state of the art. With the advent of the Internet and other technological advances, numerous job boards have come into existence, providing the tools for employers to advertise jobs world wide and for candidates from anywhere to respond almost instantaneously. These systems provide a mechanism for individuals to establish profiles with information about their employment history, skill set, degrees etc., to form an electronic resume.

Unfortunately, while modern communications systems allow anyone from around the world to search and apply in this manner instantly, the proliferation of resume submissions has considerably increased the identification or early phase work that employers must undertake in the employment process. The resumes received in this present scheme are all unverified and, as such, employers find it very difficult and even perilous to make hiring decisions based on them. Time and other resources must therefore be spent to qualify the applicants; and, even after going through all the tedious processes for this and to interview applicants, the employers still have to wait for their own HR departments (or third parties) to verify the information received before they can intelligently and safely make final hiring decisions. Additionally, the employers are continually involved in the tedious, never-ending process of manually re-verifying, over and over again, the same employment history information for each of their past and current employees every time such employees apply for new jobs or change careers.

It follows that what is needed is a system that will allow employers to receive authenticated, detailed profiles of interested applicants, in lieu of resumes, so that the identification and qualifying processes leading to employment become more manageable. The employers, universities, etc. on one hand, and the employees, students, etc. on the other hand, should be able to jointly create the profile records about individuals, profiles containing pertinent information regarding employment history, degrees held, etc. To prevent errors, by catching and correcting them promptly, and to minimize dispute about details, it is desirable that this proposed system collect information largely while the individuals are still in respective capacities as employees or students. Enhancing the overall profile is also a desirable feature, to provide individuals with the opportunity to add related information in their records regarding acquired skills and to include a descriptive cover letter. Yet further, it will be useful in such a system to allow for the creation of references by people knowledgeable about job applicants, and for these to also be associated with a candidate's profile.

Once such a system has information in it, it then needs a search engine to retrieve it for actual use. The search engine for this needs “assemble to verify business processes” for compiling individually authenticated records associated with a particular profile belonging to a candidate, and to create a coherent presentation. And once the proposed system can collect, store and retrieve the information, it needs to make its capabilities available for use. For instance, once an employment candidate identifies the jobs they wish to apply for, they should be able to simply submit an on-line link to his or her profile to prospective employers. At the receiving end, an employer can see a dynamic URL link to the candidate's profile or alternatively the unique identification number of each candidate. Clicking the link or entering the unique identification number can then take the employer to view the profiles along with other menus associated with its role as an entity within the system.

Hence, as opposed to traditional means of submission, wherein information gathered through resumes submitted by the candidates as well as information gathered from interviews needs to be verified by a hiring entity before making a hiring decision, the proposed system will allow verified information to reach the intended audience, saving time and money while being more productive with streamlined HR processes. In addition, with the proposed system, employers no longer have to manually re-verify employment history information over and over for the same employees any time someone in their employee pool applies for another position or other is involved in an other transaction where verification would be required.

Other applications can similarly benefit from such a verification system. For instance, credit services. Despite modern laws in most jurisdictions that provide consumers access to at least review their own records, consumers traditionally have not looked at their own credit profiles and do not find out about discrepancies until they are in the process of applying for loans or buying on credit worthiness. At that juncture, if there is a problem, and with the shear volume of data and the time spans involved there frequently is, the consumer gets involved in time-consuming processes to resolve the issues and is distracted from their main objective of acquiring a loan.

A digital information verification system is thus desirable to help manage and monitor credit issuance and reporting. Heretofore, there has not been a comprehensive system available for viewing and managing credit information by consumers, and a secure system for this is highly desirable.

A digital verification system can allow consumers to take control of their financial management, to allow them to have a say, and submit information to credit bureaus to proactively manage their credit history. Applying the proposed verification system in this case, credit services can allow the consumers to access their profiles on-line and report any irregularities for prompt action. Credit profiles can become part of profile databases and can be associated with the personal profiles of the consumer and the entity profiles of past credit issuers. Using modem communications systems, such as municipal networks or the Internet, for example, the consumers can instantaneously check their credit histories, and lodge formal complaints or provide clarifying notes through the means of secure on-line forms. This correcting nature of the system can be iterative, allowing immediately triggering messages back to the consumer after any changes, to prompt verification.

Concurrently, a digital verification system can also serve the needs of those issuing and reporting on consumer credit. Lenders have a strong interest to issue credit to those who are credit worthy, and these businesses need fast, complete, and verified information to do this. Credit reporting entities, similarly, need to be able to provide fast, complete, and verified information in the credit reports they issue, while minimizing the costs associated with this. Hence, business entities here can be expected to welcome the chance to off-load reviewing, updating, and large parts of error correction on those most knowledgeable about and having personal interests vested in the results, if they can verify the information.

Another, related, application that can similarly benefit from digital verification system is banking. Applying for banking services or credit cards would be greatly streamlined if lending institutions were able to verify the authenticity of the consumer and current employment instantaneously. Here it would particularly be desirable to include additional, multimedia information such as a picture of the consumer for accurate identification. The records created by the entity in this case would have the usual banking information, and yet allow the consumer to proactively manage and review their financial transactions. Similar to the credit applications described above, a means for consumers to dispute alleged transactions can be provided and can actually provide considerable benefit to financial institutions. Protected and informed consumers are happy consumers. If information is available and is used in a timely manner, and the proposed system inherently promotes this, the consumers can help protect the financial institutions against error and fraud by more promptly noticing and reporting inappropriate or wrong actions and prompting investigations.

Yet another related application is smart cards, wherein the proposed digital information verification system can help prevent fraud and identity theft (whether for financial or still other motives). With the proliferation of numerous technologically advanced electronic gadgets, smart cards are expected to be able to uniquely identify a particular device among similar devices, and to permit transactions to be associated uniquely with one device. The proposed system would enable such unique devices to be associated with the profile records of an individual. There are many potential benefits to this, but one particularly addresses a weakness of smart cards. The cards are perceived as so secure that possessing is unduly relied upon as being valid possession. The proposed system can provide a means to alert parties to the misuse or theft of the smart card device, so that identity can be preserved and fraudulent transactions can be eliminated.

In sum, what is needed is a system that can be used in a variety of environments where verified information profiles can play an important role. Many examples have been introduced, above, and additional ones will be provided, below.

### DISCLOSURE OF INVENTION

Accordingly, it is an object of the present invention to provide a system for verifying information about individuals to organizational entities.

Briefly, one preferred embodiment of the present invention is a system for verifying information about individuals to organizational entities. A process controller controls the flow of the information throughout the system. A personal base includes personal records containing information about the individuals as individual-members of the system, wherein these records are initiated by and controlled by the individual-member as a user of the system. An entity base includes entity records containing information about the entities as entity-members of the system and about the individuals as having relationships to the entity-members, wherein these entity records are initiated by and controlled by one or more representatives of the entity-member, as said users of the system. A database manager permits access to the personal and entity records, manages the creation, revision, and deletion of them, and establishes relationships between them in the personal and entity bases. And a search engine is provided that searches the personal and entity bases and compiles instances of the information pertaining to an individual-member based on the personal and entity records referring to that individual-member, wherein the information that is confirmable by correlation among multiple personal or entity records is verified information.

An advantage of the present invention is that it is flexible, having applicability and configurability encompassing many fields where verified information is needed. For example, without limitation, it may be used in employment, education, medicine, credit and banking, housing, travel ticketing, and government.

Another advantage of the invention is that it is inherently self correcting. It provides incentives and means for its information providers to participate and to maintain the accuracy of the information they provide. Concurrently, it provides incentives and means for its information subjects to participate and to maintain the accuracy of the information about them.

Another advantage of the invention is that it is inherently self policing. If an information provider proves reticent in fully participating or in maintaining information correctness, the subjects of the information can counter explain in their profiles or simply prevent the aberrant provider's incomplete or wrong information from appearing. Concurrently, the subjects of the information cannot themselves control or unduly influence its content.

And another advantage of the invention is that it provides for and encourages inclusion of information from “third parties.” It allows references to participate, with their input being correlatable against the other profile information, say, from entity information providers, and yet also suppressible by the individual information subjects, say, if the information is out of context, too dated, etc.

And another advantage of the invention is that it may be implemented currently, with conventional or emerging technologies, but without undue reliance on any particular hardware, software, or protocols.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended figures of drawings in which:

FIG. 1 is a schematic overview of an embodiment according to the present inventive digital information verification system; and

FIG. 2a-2b are block diagrams respectively showing profile records used in the personal and entity databases of the embodiment of FIG. 1.

In the various figures of the drawings, like references are used to denote like or similar elements or steps.

### BEST MODE FOR CARRYING OUT THE INVENTION

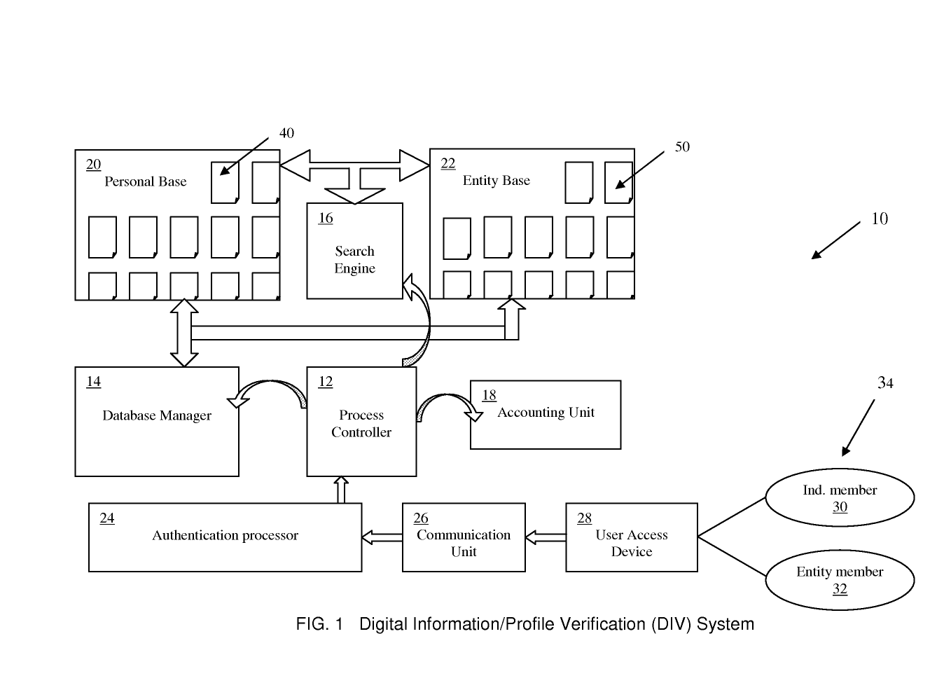

A preferred embodiment of the present invention is a digital information verification system. As illustrated in the various drawings herein, and particularly in the view of FIG. 1, this preferred embodiment of the invention is depicted by the general reference character 10.

FIG. 1 shows an embodiment of the inventive digital information verification system (DIV system 10) in schematic overview. In general, the DIV system 10 features a computer-implemented scheme utilizing multiple database configurations to aid in the exchange of information in manners consistent with industry standard security protocols. The invention may be implemented using known (and readily available) technologies such as relational architecture, database management systems, and hardware or software modules. Once the following disclosure is understood, those possessing skills in the arts of database management and application programming will be able to make and use the invention using commercially available database systems.

The DIV system 10 may include many additional, optional features. For example, such may include the use of multimedia information, consisting of audio or video in combination with text, still images, or other digital computer data to extend the usability of the underlying information being verified and presented.

It should also be noted that since network technology continues to evolve, and the availability and sophistication of network facilities varies greatly among users, the DIV system 10 may be implemented to function over a variety of networks and to adapt to the network currently available. With such network-independence, the DIV system 10 can provide the coupling of structured information and multimedia presentation to fit the needs of various remote user units, including but not limited to computers, terminals, handheld devices, kiosks, etc.

As shown in FIG. 1, a preferred embodiment of the DIV system 10 may include a process controller 12 that manages the flow of information throughout the DIV system 10 and controls the execution of three major operational units, namely, a database manager 14, a search engine 16, and an accounting unit 18.

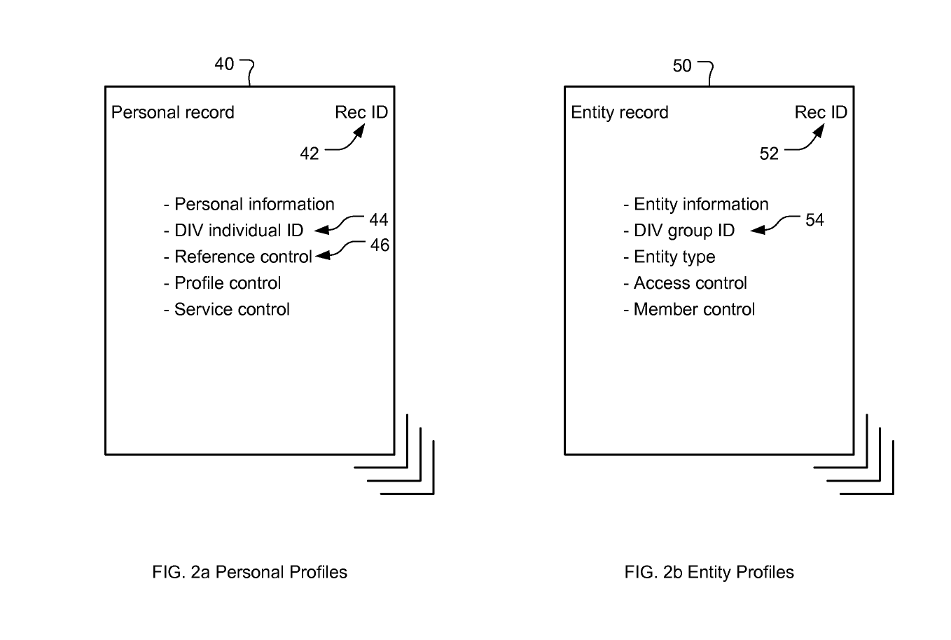

The database manager 14 performs configuration and management tasks associated with the creation and revision of records contained in two separate databases, namely, a personal base 20 and an entity base 22. Both of these databases may each be configured as either a single database or a cluster of individual databases. The database manager 14 also associates records in the personal base 20 and the entity base 22 to establish relationships therebetween. In the inventor's presently preferred embodiment, this is done by establishing entries in respective relation tables that include one or more DIV individual IDs or one or more DIV group IDs (see e.g., FIG. 2a-b).

The search engine 16 compiles diverse profile information in the personal base 20 and the entity base 22 pertaining to specific DIV individual IDs. It also compiles a coherent database of results with dynamic links to allow navigation through various portions of record groupings, depending on the type of user currently employing the DIV system 10.

The accounting unit 18 is an important part of the DIV system 10, but is described in detail toward the end of this discussion, after context for it is better provided.

The DIV system 10 also includes an authentication processor 24, a communication unit 26, and a single or multiple user access devices 28. The authentication processor 24 and the communication unit 26 may be local to the process controller 12, and may even be integrated into it. In contrast, the user access devices 28 are typically remote from the other components of the DIV system 10, making them easily available to the two major classes of users of the invention, namely, individual-members 30 and entity-members 32 (collectively users 34).

According to the inventor's presently preferred embodiment, the user access devices 28 are personal computers, PDAs, terminals, kiosks, etc., that are connected to one or more networks ultimately including the DIV system 10. Access thus may be achieved via the Internet or through local area networks (LAN), wide area networks (WAN), or metropolitan area networks otherwise connected to the DIV system 10.

The software and middleware technologies usable by the DIV system 10 are also presently available, although not heretofore assembled together. As is already standard practice when dealing with the precious commodity of information, security protocols can be used. For example, digital certificates are already in wide use in personal computers, and the inventor contemplates that most of the user access devices 28 will use these or a suitable equivalent when communicating with the communication unit 26. When appropriate, it is a simple matter for the DIV system 10 to require the use of a secure protocol.

Those accessing the DIV system 10 will usually be either individual-members 30 or entity-members 32. Any user 34 who is not an entity-member 32 is treated as an individual-member 30. According to the DIV system 10, an entity-member 32 is a duly authorized representative of a business-like entity, such as an employer, lending institution, bank, credit bureau, airline ticket issuer, etc. Conversely, an individual-member 30 is usually a duly authorized person representing themself, such as an employee, employment applicant, credit applicant, student, etc.

The users 34 accessing the DIV system 10 are granted appropriate privileges upon successfully executing identification or verification protocols, which maybe in the form of a password, smart card, biometric, etc. The authentication processor 24 handles initial security and determines or “flags” the different types of the users. This is done with the established DIV individual IDs or DIV group IDs being submitted in conjunction with the passwords. The authentication processor 24 additionally verifies the authority of the entity-members 32, based on the nature of the entity they belong to. Hence, once a user-type has been determined, the authentication processor 24 sets an entity flag and informs the process controller 12 about the type of user and represented entity accessing the DIV system 10, so that a variety of pertinent menus may be presented.

For instance, if a user accessing the DIV system 10 supplies a DIV individual ID AND a valid password, that user is classified by the authentication processor 24 as an individual-member 30. This enables the process controller 12 to present relevant menus associated with individual-members 30, and these allow the user to access and revise the database records established in their individual-member 30 type profile account in the personal base 20.

On the other hand, if the user accessing the system supplies a DIV group ID AND a valid password, that user is classified by the authentication processor 24 as an entity-member 32. This enables the process controller 12 to present relevant menus for this type of user, and to allow access to the appropriate entity database file maintained in the entity base 22.

Of course, a user can exist in the DIV system 10 in many capacities. They may, for example, be an individual-member 30 that is, concurrently, a part-time graduate student, an employee with one entity, a prospective employee at one or more other entities, and a credit applicant. The very same individual-member 30 may even also be a representative of an entity-member 32, say, while working in the HR or credit department of one entity-employer. As such, a user may employ a separate DIV group ID for each capacity they fill as a duly authorized entity-member 32 (which rarely will be more than one such capacity, but not necessarily so). A user may have only one DIV individual ID, as an individual-member 30, regardless of how many capacities they fill as a duly authorized representative of entity-members 32. Other schemes are quite possible, but the DIV system 10 works particularly efficiently and securely with these.

Similarly, an entity-member 32 may exist in the DIV system 10 in multiple entity capacities. For instance, a university typically will be an educational system, primarily. But it concurrently also may be an employer, a housing provider, a credit institution, etc.

FIG. 2a depicts a sample format for a personal profile as might be used in the personal base 20 of FIG. 1. The personal base 20 is a database configured to contain personal records 40 which are formulated by the individual-members 30. Each of these personal records 40 forms a subset of the information associated with each individual-member 30 that may be presented to the entity-members 32 (or authorized business entities that are not members of the DIV system 10). The personal base 20 may be a single database file or a collection of database files (see e.g., FIG. 1), with each comprising multiple personal records 40 and each including a number of predefined fields. Generally, these fields will contain searchable parameters and descriptive information for the individual-members 30. According to the inventor's presently preferred embodiment, the search parameters include a unique record ID 42, a DIV individual ID 44, the name of the individual-member 30, etc. The personal record 40 may also contain control fields associated with references, the personal profile usage, services subscribed to, etc.

FIG. 2b depicts a sample format for an entity profile as might be used in entity base 22 of FIG. 1. The entity base 22 is a database configured to contain entity records 50 that are formulated by the entity-members 32. The entity base 22 may also be a single database file or a cluster of database files. Each entity profile contains an entity record 50 that uniquely identifies the entity-member 32, and database records pertaining to each employee- or consumer-client belonging to the entity-member 32. Each entity record 50 also includes a number of predefined fields and, generally, these fields will contain searchable parameters and descriptive information for the entity-members 32. According to the inventor's presently preferred embodiment, the search parameters here include a unique record ID 52, a DIV group ID 54, the name of the entity-member 32, etc. The entity record 50 may also contain control fields associated with entity type, accesses permitted, member services, etc. Each entity database will also include records of each employee of the entity-member 32, or each consumer or client of the entity-member 32, or both, for entities such as universities, credit bureaus, etc., that have dual entity status.

For example, if the entity-member 32 is an employer, the entity record 50 will identify the member as such and the associated database records will contain employee records. Each such employee record can include an appropriate predetermined set of fields for this entity type, such as employee name, job titles held, and start and stop dates of each position held with this particular employer. The employee records may also include narrative fields containing descriptive information about initial (and final) job responsibilities, terms of employment, reporting structure, supervisor and HR director comments, initial (and final) salary, etc.

If the entity-member 32 is a credit reporting agency, instead, the entity record 50 will identify the member as such and the associated database records will contain consumer records. Each such consumer record may then include an appropriate predetermined set of fields for this entity type, such as consumer name, type of credit services acquired, and narrative fields that advantageously specify the transaction history, credit worthiness, etc., that are normally associated within the parameters currently established by the credit bureaus.

On the other hand, if the entity-member 32 is an university, the entity record 50 will identify the member as an educational system. The associated database records will then contain graduate records that include information about all of the students currently graduating, as well as all who have previously graduated from this university. Each such record can also include a predetermined set of appropriate fields for this entity type, such as the name of the graduating student, type of degree awarded, graduation date, and any other narrative fields that may advantageously specify information associated with the educational background of a graduating student.

As noted earlier, an entity-member 32 such as a credit bureau, university, etc., may have dual (or more) entity status associated with its membership in the DIV system 10, since it would have both employees as well as consumer-clients. For these entity-members 32, the database records associated with an entity record 50 can contain records of each employee of the entity-member 32, as well as with each consumer-client. These can advantageously configured to be accessed and managed under the same DIV group ID 54. For instance, in the case of a university, an entity record 50 may contain associated database records of current and former university employees and staff, as well as records of currently graduating and formerly graduated students. And consistent with features previously discussed, these may be setup as either single or separate, multiple databases.

With reference again to FIG. 1, it is the database manager 14 that manages the creation, revision/modification, and maintenance of database personal records contained in both the personal base 20 and the entity base 22. The database manager 14 also enforces the security and password protocols associated with all database records in the DIV system 10, to specify who may have access to the records for the purpose of revising, maintaining, and archiving them. When the users 34 select options from their menus to create or modify either the personal or entity profile databases, the process controller 12 submits commands to the database manager 14, which in turn drive the databases, passing information fields contents and initiating necessary control actions to effectively manipulate the intended database records. The mechanisms involved in the creation and manipulation of the database records of both the personal base 20 and entity base 22 are now explained.

The creation of the entity base 22 involves two separate major steps. First, through appropriate security measures and verification protocols, legitimate businesses, universities, employers, etc., are awarded status as entity-members 32 each provided with a uniquely identifying DIV group ID 54 and a valid password. As part of this, a basic entity record 50 is formed within the entity base 22. In the second step, the entity-members 32 establish additional records for their pool of employees, clients, graduating students, etc., in their database file, with relational cross-references back to their own entity record 50. So, for instance, an employer would create records for each of its employees and, together with its own entity record 50 this would form its entity profile. Such records, or small databases in their own right, together form the entity base 22.

It is to be understood that to ensure privacy and authentication, the employers and their individual employees jointly create individual database records, and that any subsequent revisions/modifications of already authenticated records pertaining to an employee can be executed by the employer only if a DIV individual ID 44 and password of the employee also accompanies such update commands. Essentially, both the employer authorization AND the employee authorization are required to commit an update/revision request. Hence, an employer cannot, by its sole discretion, change authenticated records without the knowledge and authorized consent of the employee in question. By the same token, an employee cannot change authenticated records without the knowledge and authorized consent of their employer, thereby assuring safe practices.

However, it should be noted that joint creation of individual database records does not necessarily mean that both the employer and their individual employees have to be physically present at the same time; it would suffice for the employer to set up individual employee records, and when such individual-members 30 access their personal records 40 by using their DIV individual ID 44 and password combination, they can be alerted about new records created by their employer. A menu option can then be presented to allow them to examine and approve or dispute the new records, whereupon these records will attain authenticated status. This alternative method is particularly useful in the case of past employees who are no longer physically available to establish records at their prior employers.

As mentioned above, when an entity-member 32 accesses the DIV system 10 a variety of menu options are presented, depending on the type of entity. For employers, the menu options may allow the following:
to create authentic employment records, together with authorization from individual employees;
to edit/modify those records, such as while updating the data for promotions, title or responsibility changes, etc., or to close the database record permanently (i.e. when the employee is no longer employed by the employer);
to accomplish account management, wherein the employer designates or changes authorized HR personnel that create, revise or otherwise maintain the database records of that entity-member 32; and
to verify the employment and degree records of current or prospective employees, but only if authorized to view such records (as described presently).

In a similar manner, educational institutions, such as universities, etc., create their respective entity records 50 and corresponding database records of all of their graduated students, employees, student loan recipients, etc.

It is to be understood that each individual-member 30, whether an employee, student, client, consumer, etc., may be assigned a single unique DIV individual ID 44 by the DIV system 10, so that any information pertaining to that person can always be assembled into a coherent presentation regardless of where the various records pertaining to an individual-member 30 may reside within the potentially numerous database clusters of entity records 50.

The creation of the personal base 20 is formulated by the employee, student, client, consumer, etc., and is established by the creation of personal records 40 by the individual-members 30. The personal records 40 contain information created exclusively by the individual-members 30 and, as such, are generally construed by the DIV system 10 as containing unverified information. An exception to this, however, can be made for records pertaining to skills and references (discussed presently).

As described above, an employee (as an individual-member 30) is always in control of their DIV individual ID 44 and corresponding password. Database records reflecting authentic employment records for them are created together with each of their current and previous employers (as entity-members 32). Accordingly, when the employee accesses the DIV system 10, using their unique DIV individual ID 44 and password combination, they may be presented with appropriate menu options that allow the following:
to review and authorize newly created employment records;
to check that their employment records are in the same state as at last authorized; and
to add, round out, or otherwise complete information about their employment or degree profile, such as skills acquired, cover letters, references, any job or degrees that are yet to be verified, etc.

It is to be noted that only this type information need be reflected in the personal records 40, and not any of the already authenticated entity records 50, which can remain “owned” and managed by the respective entity-members 32 with which an employee is or once was associated.

The DIV system 10 may additionally be configured to use a skill-rating system that determines the strength of each skill listed by an individual-member 30. Such a skills rating system has clear and immediate benefit for employment purposes, but it may also be employed by other types of entities, such as educational institutions. Using this system, the results of testing may then appear as a verified entry in the personal record 40. Alternately, the skills section may instead or additionally have a provision for the individual-member 30 to list their skills without using a skills-rating system. These entries would then be listed as unverified.

When a skills-rating system is used, it can include exhaustive testing designed to evaluate the knowledge of a particular subject. For instance, testing may be in the form of a multiple choice test, answer entry, essay, or other format suitable for the rating sought. An entity-member 32 may provide the test, say, a prospective employer, or third-party skills evaluators may be employed. In particular, the test may be provided online, either integrated into the DIV system 10 or in the form of a link to the test elsewhere. Upon completion of a test the results are incorporated into the skills section as a verified entry, indicating as well as validating the knowledge of the subject matter by the individual-member 30.

For example, when a technical programmer as an individual-member 30 lists a skill in a programming language, say C++ or JAVA, and tries to update the skills section their personal record 40, the DIV system 10 can immediately provide a C++ or Java skills test. When the test is completed, the results can be included with an indicator that this skill is verified. Similarly, if an employee lists management in their skills section, a pertinent test can be provided and the results can be incorporated within their skills section. It should be noted that the skills tests may additionally include behavioral profiling tests, to help bring about a perfect fit between potential employers and employees.

The personal record 40 also provides a mechanism for individual-member 30 to establish a list of references. Once such a list is proffered, the DIV system 10 can prompt each person listed to provide the reference. When the references are completed by their providers, they become part of the personal record 40 for the individual-member 30 and are reflected as verified entries which may not be modified by the benefited individual-member 30. The references may be for many purposes, e.g., employment, credit, housing, and the individual-member 30 can control which references are seen in any particular context.

As explained in creating the entity records 50, the employers AND the employees jointly create entity database records. The employer is presented with various standard menu options, and additional entries or fields may also be provided, to enable the participating entity-members 32 to specify a set of mandatory fields as established by company policies or as governed by federal, state, and local laws. Each field in the creation of these records may be advantageously presented in the form of lists or scroll down menu items for ease of use, and as a means to eliminate exhaustive typing requirements. So for instance, while establishing a title for an employee, the authorized personnel of entity-members 32 maintaining the entity records 50 in the DIV system 10 can pick the title from a scroll down list of all the titles available within the system, or create a new title by entering the new title in the filed. Any new such titles added in this manner then is reflected in the scroll down menu so that it may be available as a choice for future use.

It should be noted that the same principle can apply to almost all of the fields established in the DIV system 10, so that every entry becomes a click-able choice for future use by the members, thereby making the entire system much easier to use. The DIV system 10 forces any updates or changes to require re-authorization from both the employer AND the employee whose records are being updated or otherwise modified. This circumvents unauthorized changes to existing verified entries. In addition, the employees create their personal records 40 with various menu options that allow for the creation of skills profile, reference listings, cover letters, and other yet-to-be verified information as well as non-verifiable information such as self-study, courses, trainings etc.

When an employee comes across interesting jobs listed, regardless of the job-listing source, instead of sending a resume residing in their computer or from a profile established at any of the numerous job-boards today, the employee as an individual-member 30 can just respond including their unique DIV individual ID 44. This may be submitted to the employer as an entity-member 32 in many ways. For example, it may be provided within the DIV system 10 to the hiring manager of the employer as a click-able URL link. Or it may be provided as an email with a link to the employee's profile. Basically, any suitable form of online interaction may be used.

This process of applying for jobs may be accomplished by a menu option provided to employees as individual-members 30 when they are logged into their account using the DIV system 10. The menu option would then send a click-able URL link to any entity-member 32 identified and entered by the employee in a form field presented. The employee may optionally use an email system and list the complete URL link to their profile and their unique DIV individual ID 44. The employee then sends the email to a potential employer, as an indication of interest in a particular job. When the representative of the entity-member 32, clicks on the URL link containing an unique DIV individual ID 44 associated with the candidate applying for the job, the process controller 12 invokes the search engine 16. The search engine 16 then executes a search of all the records contained in both the personal base 20 and the entity base 22 and retrieves all of the records pertaining to the DIV individual ID 44 from the database clusters therein. The process controller 12 then invokes the database manager 14 to present the gathered information in an “assemble-to-verify” type presentation format. For example, all of the records may be represented in a coherent reverse chronological format, with separate sections for employment history, degrees, references, skills, cover letters, etc., and with navigational links so that the recipient can browse through the information with ease. These separate sections would typically comprise both verified and unverified information to provide continuity of career history, and the verified portions may appear with digital certificates carrying a certified stamp of authenticity.

It should be noted that the presentation format can be varied, and may be customizable by the entity-member 32, depending on what uniform format is in keeping with their own HR practices and HRIS system policies. The DIV system 10 thus allows for the recipient to easily import all of the presented information into their own HRIS or resume management system, since the data contained in all of the sections can coincide with the usual data fields associated with traditional resume structures or applicant tracking systems.

The DIV system 10 allows an employment application to be delivered and to accommodate authentic, verified information regarding career history, degrees held, etc. While unverified information is also included to provide continuity of career history, the already verified information can carry a certifying stamps of authenticity as digital “certificates.” This streamlines the application processes and enables hiring decisions to be made faster and more accurately.

It is also contemplated that the recipient may not necessarily be a formal entity-member 32 to view the “authenticated profile” of a candidate applying to a job listed by the entity. The DIV system 10 allows employees as individual-members 30 to send their authenticated profile to any entity or hiring manager, regardless of whether the receiving entity is an entity-member 32 or not.

However, to safeguard privacy and to protect the interests of the entity-members 32 and their corresponding employee-pool, the DIV system 10 may inherently be implemented to be a closed response system, so that entity-members 32 cannot search or otherwise get any information about any employee associated with other entity-members 32. To achieve this the ways an entity-member 32 can avail itself of the authenticated records of a potential employee can be limited. Firstly, access can be permitted if a potential employee supplies their unique DIV individual ID 44 as part of applying for a job with the potential employer (regardless of whether that is an entity-member 32 or not). Alternately, the employee, by their own consent or action, may choose to list their profile in an unrestricted access area of the DIV system 10. In most embodiments, the inventor contemplates that only the entity-members 32 will have the ability to browse through such open-listed, authenticated profiles with the aid of the search engine 16. Hence, the DIV system 10 can prevent unauthorized access to employee-profiles. At all times, each entity-member 32 can own and maintain the information pool of its employees, while those (current or past) employees as individual-members 30 control access to their profiles. In addition, the databases used in the DIV system 10 may be advantageously configured such that all records pertaining to each unique ID 44, 54 are in separate database clusters, so that only the action of the search engine 16 to “assemble-to-verify” an execution brings together information that would be coherent. Also, the entity records 50 created by the employers may be governed by applicable federal, state and local laws, as well as any corporate policies. The DIV system 10 hence may act to ensure that local laws, rules, and regulations are followed, such as those pertaining to FCRA, FLSA, OSHA, etc., in the United States. As such, the invention may support an objective measure of compliance with hiring standards.

As noted above, various menu options are presented to an employee as an individual-member 30 upon successfully signing on to the DIV system 10. These may allow the employee to control many aspects of their profile. For instance a reference control 46 allows for maintaining a list of references. When such reference records are completed by the reference providers, they become part of the employee profile record and are reflected as verified entries which may not be modified by the employee. However, the employee still retains control of the visibility of these records, and can control which references they want to be visible to an authorized access by a potential employer. The employee can suppress references that are no longer necessary. In a similar manner, profile control menus allow the employee to deny access to a potential employer who previously had access to the member profile. As an example, when a employee terminates tenure with their employer, who is also an entity-member 32, the employee can use the profile control menus to deny or “block” this employer from accessing or changing any further employment or related information. The DIV system 10 may be advantageously configured so that prior employers can only get verified information about their past employees, and then only that information that pertains to the periods that the employee was in service or tenure with that employer. This mechanism prevents prior employers, who are already privy to the DIV individual ID 44 of past employees, from having unauthorized access to current information related to the past employees.

Turning now to the accounting unit 18, in the inventor's presently preferred embodiment of the DIV system 10, whenever a business entity becomes an entity-member 32 it is invoked to track charges in the form of a basic subscription charge, predetermined based upon the number of employees serviced by the employer. Other charges, beyond the basic subscription, are also established for related or additional transactions. Of course, a variety of other payment schemes may also be established to charge the entity-members 32 for the services rendered to them.

The accounting unit 18 may also be used to apply other charges to the entity-members 32. For example, it can handle charging for use of the skills-rating systems. It may also be advantageously configured to track various other activities, so that additional services such as report generation, statistical information, etc. can be made available to help meet the needs of the members of the DIV system 10.

The above preferred approach perpetuates the traditional employer-pays model, wherein the individual-members 30 can be allowed free use of the DIV system 10. That model, however, is not traditional in some other contexts. For example, systems for applying for credit or housing often use an applicant-pays model. The inventive DIV system 10 can then, flexibly, be implemented to employ this scheme, alternately or even additionally, based on the transaction context.

The DIV system 10 has been described here by referencing a preferred embodiment using instantaneous, online employment and degree verification; creating and profiling authenticated information; managing the personal base 20 and the entity base 22 databases; applying for jobs online or through electronic mail; and, changing the delivery mechanism by replacing conventional unverified resumes with authenticated profiles all certified from respective originating sources. Other uses of the invention that have been noted in passing are in housing, banking services, credit bureaus, and educational institutions. The inventive DIV system 10, however, is not necessarily limited to just a set group of industries. It has potential application anywhere an authenticated information exchange is required.

While various embodiments have been described above, it should be understood that they have been presented by way of example only, and not limitation. Thus, the breadth and scope of the invention should not be limited by any of the above described exemplary embodiments, but should be defined only in accordance with the following claims and their equivalents.

### INDUSTRIAL APPLICABILITY

The present DIV system 10 is well suited for use in a wide variety of applications. Examples have already been provided in employment, education, finance, and housing. The invention is not limited, however, to specific industries or fields. Two examples of critical information-using entities have been saved until now to emphasize this: medicine and government. A hospital must have verified information when it administers or dispenses many medications, and a government must have verified information when it provides a passport, drivers license, or other identity document. The problem that the DIV system 10 solves is universal: information about individuals is only useful to entities (the invention's entity-members 32) if it can be trusted. The invention thus permits enough of the content in a profile of information about an individual to be verified that a sound decision can be made.

The inventive DIV system 10 also serves its individual-members 30 well. It pragmatically acknowledges fact that they are usually the ones who are most knowledgeable if the information about them it is correct, complete, timely, etc. And that they typically will be the ones most motivated and proactive to see to that. The invention thus makes them, by in large, the masters of their own information. It empowers them review the information about them, to initiate correction of it, and to police against its wrongful use.

The DIV system 10 brings together many of the best technologies in the computer, communications, and security fields. It is not limited to any specific hardware, software, or security scheme. Its hardware may be highly integrated or widely dispersed. It particularly may be employed with wide area networks, such as municipal public-access networks or the Internet. Its users 34 may employ it using conventional or new types of user access devices 28. Its personal base 20 and entity base 22 may be singular or clusters of multiple databases. It may employ security protocols that are rigorous, such as digital certificate stamping, or ones deemed merely sufficient for most cases, such as regarding information verified if it appears and substantially cross correlates across multiple records.

For the above, and other, reasons, it is expected that the DIV system 10 of the present invention will have widespread industrial applicability. Therefore, it is expected that the commercial utility of the present invention will be extensive and long lasting.

1: A system for verifying information about individuals to organizational entities, comprising:
a process controller that controls the flow of the information throughout the system;
a personal base that includes personal records containing information about the individuals as individual-members of the system, wherein said personal records for each said individual-member are initiated by and controlled by that said individual-member as a user of the system;
an entity base that includes entity records containing information about the entities as entity-members of the system and about the individuals as having relationships to said entity-members, wherein said entity records for each said entity-member are initiated by and controlled by one or more representatives of that said entity-member as said users of the system;
a database manager that permits access to said personal records and said entity records and that manages creation, revision, and deletion there of, and that establishes relationships therebetween in said personal base and said entity base; and
a search engine that searches said personal base and said entity base and compiles instances of the information pertaining to a said individual-member based on said personal records and said entity records referring to said individual-member, wherein the information that is confirmable by correlation among multiple said personal records or entity records is verified information.

2: The system of claim 1, further comprising an authentication processor that identifies the type of a said user accessing the system, as either a said individual-member or a said entity-member, and that establishes the nature of usage of the system permitted by said user.

3: The system of claim 1, further comprising a communication unit that permits communications of a said user with the system via a user access device.

4. (canceled)

5: The system of claim 1, wherein said personal base includes a cluster of individual databases, each said individual database containing said personal records for one said individual-member of the system.

6: The system of claim 1, wherein at least one of said personal records for a respective said individual-member contains personal profile type instances of the information provided by said individual-member themself, and one or more of said personal records for said respective said individual-member contain reference type instances of the information provided by others about that said individual-member.

7: The system of claim 1, wherein said personal records include multimedia type instances of the information about said individual-members of the system.

8: The system of claim 1, wherein said entity base includes a cluster of individual databases, each said individual database containing said entity records for one said entity-member of the system.

9: The system of claim 1, wherein at least one of said entity records for a respective said entity-member contains organization profile type instances of the information provided by said entity-member, and one or more of said entity records for said respective said entity-member contain representative type instances of the information provided by said entity-member about its authorized representative who may use the system on its behalf.

10: The system of claim 1, wherein said database manager builds and maintains said personal base and said entity base as relational databases having one-to-many and many-to-many relation entries for said personal records and said entity records.

11. (canceled)

12: The system of claim 1, wherein said search engine compiles a records database for a said individual-member having dynamic links to allow navigation through various portions of record groupings therein.

13: The system of claim 12, wherein said search engine compiles said records database iteratively, following all entries for a said individual-member in said personal records and in said entity records to maximize said verified information.

14: The system of claim 2, wherein said authentication processor controls access of a said user to the system, based upon a user identifier and a verification protocol.

15: The system of claim 14, wherein said verification protocol includes a member of the set consisting of passwords, smart cards, and biometrics.

16: The system of claim 3, wherein said communication unit communicates with said user access devices of said users of the system via a global communications network.

17: The system of claim 1, wherein said process controller notifies said users of a change to the information pertaining to their said personal record or said entity record, and requests whether said users authorize said change.

18: The system of claim 17, wherein said change is treated as a request and said request is not formally acted upon until said individual-member or said entity-member for a respective said personal base or said entity base has authorized said change.

19: The system of claim 1, wherein:
said personal base includes personal records for individual-members as past, present, and prospective future employees; and
said entity base includes entity records for employers.

20: The system of claim 19, wherein said employees have established a profile of the information in the system about them which said employers may access.

21: The system of claim 20, wherein:
said employees have an identifier within the system; and
said employees request the system to provide access to said employers based upon use of said identifier.

22: The system of claim 21, wherein said employees request a member of the set consisting of the system to provide said identifier to prospective said employers and the system to search said personal base and said entity base based on said identifiers for prospective said employees.

23. (canceled)
